(19) United States
(12) Patent Application Publication
(10) Pub. No.: US 2024/0378829 A1
(43) Pub. Date: Nov. 14, 2024

(54) FINE-GRAIN PLACEMENT AND VIEWING OF VIRTUAL OBJECTS IN WIDE-AREA AUGMENTED REALITY ENVIRONMENTS

(71) Applicant: tagSpace Pty Ltd, Brisbane (AU)

(72) Inventor: Paul Simon Martin, Sydney (AU)

(21) Appl. No.: 18/780,299

(22) Filed: Jul. 22, 2024

Related U.S. Application Data
(63) Continuation of application No. 16/945,105, filed on Jul. 31, 2020, now abandoned.
Application No. 16/945,105 is a continuation of application No. 15/600,449, filed on May 19, 2017, now abandoned.
(60) Provisional application No. 62/340,110, filed on May 23, 2016.
(60) Provisional application No. 62/340,118, filed on May 23, 2016.

(51) Int. Cl. G06T 19/00; G01S 19/14; G01S 19/39; G01S 19/40; G01S 19/52; G01S 19/53; G02B 27/00; G02B 27/01; G06F 3/01; G06T 7/70; G09G 3/00

(52) U.S. Cl. CPC G06T 19/006; G01S 19/14; G02B 27/0101; G06F 3/011; G01S 19/396; G01S 19/40; G01S 19/52; G01S 19/53; G02B 27/0093; G02B 27/017; G06T 7/70; G06T 2200/04; G06T 2219/2004; G09G 3/003

(57) ABSTRACT

Provided herein are exemplary embodiments directed to systems and methods of receiving a reference origin, the reference origin including a first longitude, a first latitude and a first altitude above sea level, receiving a point of interest, the point of interest including a second longitude, a second latitude and a second altitude above sea level, and receiving an updated reference origin, the updated reference origin comprising a third longitude, a third latitude and a third altitude above sea level. Further exemplary embodiments include associating digital data with the point of interest.

### CROSS REFERENCE TO RELATED APPLICATION

This application is a continuation of U.S. application Ser. No. 16/945,105, filed Jul. 31, 2020, which is a continuation of U.S. application Ser. No. 15/600,449, filed May 19, 2017, which claims the benefit of U.S. Provisional Patent Application Ser. Nos. 62/340,110, filed May 23, 2016, and 63/340,118, filed May 23, 2016, all of which are incorporated by reference herein.

### FIELD OF INVENTION

Embodiments of the disclosure relate to the placement of digital data in augmented reality environments.

### SUMMARY

According to some exemplary embodiments, methods include receiving a reference origin, the reference origin including a first longitude, a first latitude and a first altitude above sea level, receiving a point of interest, the point of interest including a second longitude, a second latitude and a second altitude above sea level, and receiving an updated reference origin, the updated reference origin comprising a third longitude, a third latitude and a third altitude above sea level. Further exemplary methods include associating digital data with the point of interest, adding a 3D offset to the point of interest to determine a location for the point of interest, determining a threshold, the threshold representing a predetermined change in distance of the reference origin, updating the reference origin when the threshold is met or exceeded, and/or receiving an initial location, the initial location including GPS coordinates of a client device, an altitude above sea level of the client device and an offset from the altitude above sea level of the client device.

Various exemplary methods include creating by the client device a virtual East North Up coordinate system based on the initial location, receiving a current course location of the client device, the current course location including new GPS coordinates, and receiving digital data associated with an offset. Additional methods include creating by the client device a virtual East North Up coordinate system based on the initial location, the current course location including a new altitude above sea level of the client device, recording the current course location and the new altitude above sea level on the client device, inputting the current course location and the new altitude above sea level of the client device into a filter, and/or fusing the filtered information with data from sensors to estimate a position in East North Up coordinates.

Other exemplary methods include receiving an initial location, receiving a current course location, determining a difference between the initial location and the current course location, receiving acceleration data and GPS speed, filtering the acceleration data, the GPS speed and the difference with a filter, and outputting improved location coordinates. Other exemplary methods include filtering latitude, longitude, and altitude data with the filter.

Certain exemplary methods include receiving location data, the location data including GPS coordinates, formatting the location data for a filter, inputting the location data into the filter, and filtering by the filter the location data and altitude data. Additional exemplary methods include obtaining from a sensor on a client device additional data for filtering by the filter.

Exemplary systems include a computing device, the computing device further comprising a GPS receiver, a sensor, a network communication means communicatively coupled to the GPS receiver, the sensor and a network, and a filter communicatively coupled to the computing device. The filter may include a data converter.

Further exemplary methods may include viewing through a viewport on a client device a first 3D digital media object placed in an augmented reality space, the first 3D digital media object remaining in a fixed position within the augmented reality space while moving the client device in a real world setting. Additional exemplary methods include receiving an initial location, the initial location including GPS coordinates of the client device, an altitude above sea level of the client device and an offset from the altitude above sea level of the client device, creating by the client device a virtual linear coordinate reference system based on the initial location, receiving a current course location of the client device, the current course location including new GPS coordinates, and receiving digital data associated with an offset. Other exemplary methods may include the moving of the client device in the real world setting including moving around the first 3D digital media object that remains in the fixed position and/or wherein the first 3D digital media object was placed in the augmented reality space by a third party. The first 3D digital media object may be placed in the augmented reality space by a user of the client device, the user of the client device may place a second 3D digital media object relative to the first 3D digital media object, and/or a third party may place a second 3D digital media object relative to the first 3D digital media object.

### DESCRIPTION OF THE DRAWINGS

Certain embodiments of the present technology are illustrated by the accompanying figures. It will be understood that the figures are not necessarily to scale. It will be understood that the technology is not necessarily limited to the particular embodiments illustrated herein.

FIG. 1 is an exemplary example illustrating a user navigating the world using an AR device and placing digital media in that world.

FIG. 2 is an illustration of an exemplary user view from a client device running digital media software where by the user has placed a single digital media object in an AR environment.

FIG. 3 is an illustration of an exemplary user view from a client device running digital media software where by the user has placed multiple digital media objects in an AR environment.

FIG. 4 is an illustration of an exemplary user view from a client device running digital media software where by the user has placed a Media Tag in an AR environment.

FIG. 5 is an illustration of an exemplary process for calculating real world locations and converting them into virtual ENU computer graphic space coordinates for precise placement of digital media in an AR environment.

FIG. 6 is a flowchart of an exemplary process that digital media software running on a client device may perform for calculating and converting real world locations into virtual ENU computer graphic space coordinates for precise placement of digital media in an AR environment.

FIG. 7 is a flowchart of an exemplary process that digital media software running on a client device may perform to obtain an accurate altitude for the user's device at a given GPS location.

FIG. 8A is an illustration of an exemplary process for calculating the orientation of digital media being placed in an AR or VR environment.

FIG. 8B is an illustration of an exemplary process for calculating the normal of digital media being placed in an AR or VR environment. This normal may then be used to store the orientation of digital media.

FIG. 9 is a block diagram of an exemplary system for filtering GPS and acceleration data from a client device to provide the most accurate and precise location possible, given a variety of inputs and constraints.

FIG. 10 is a block diagram of an exemplary example showing the components and processes that may be involved in implementing a filter and/or fusion system.

FIG. 11 is an illustration of an exemplary example of a user viewing digital content through their client device which has digital media software utilizing various exemplary embodiments to view that object as intended by its placement author.

FIG. 12 is a flow chart of an exemplary architecture depicting the physical system components for practicing aspects of the present technology.

### DETAILED DESCRIPTION

Given the two-dimensional nature of existing social media content and the current limits of existing immersive AR and VR systems, the creation, sharing, and viewing of classic social media content is not possible within AR and VR 3D computer-generated environments.

Current social media platforms are unable to precisely determine the locations of users because users lose context for their posts since only coarse-grain places can be associated. For example, “I am currently somewhere in Centennial Park” versus “I am currently sitting on the park bench that is closest to The Pavilion at Centennial Park”.

In terms of existing AR and VR solutions, these systems typically have limits including, but not limited to:
inaccurate location-based anchoring which utilises a GPS receiver to attain a current coordinate in the world.
inaccurate real-world anchoring of graphics content (i.e. content shake or jitter).
low-precision location of graphics content (e.g. positional fluctuation of +/−10 metres from session to session).

What is needed is a mechanism that allows for precise and accurate placement of digital media (including social media information) in a digital AR or VR environment. Such a mechanism should allow users to accurately, consistently, and repeatedly view that digital content across a variety of users and devices given variations in both technical and environmental variables.

In order to meet these goals, the mechanism should strive to achieve the following:
maintain stable and precise localisation and orientation without helper markers (i.e. attain a user's position in the world to an accuracy of +/−1 centimetre and with an accuracy of +/−0.001 degrees in some exemplary embodiments).
obtain an acceptable level of “motion anchoring” (i.e. achieving visual stability of all computer graphics content relative to their perceived location in the real world).

A method for allowing users to place, locate, and view virtual digital media objects (“digital media”) in AR environments at greater accuracy than is attainable by using GPS coordinates alone. This method also enables the reciprocal ability for a viewer to view those digital media instances from arbitrary viewpoints such that the digital media appears at the same location, and optionally orientation, as the creator intended. A viewing user could be the author that placed the digital media or another user. Digital media may be placed within a computer world graphics coordinate system that has its origin located at a single parent GPS (latitude/longitude/altitude) coordinate). Certain aspects of this method also apply to VR worlds.

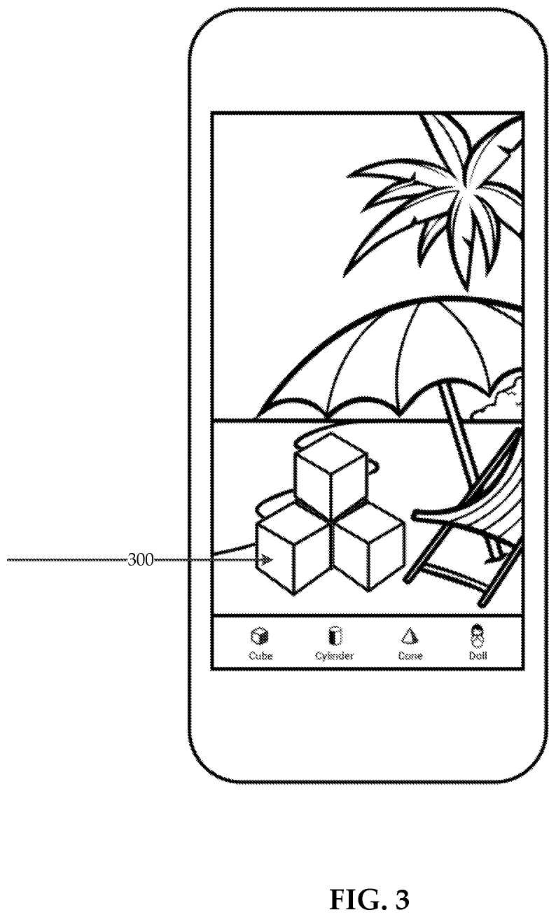

The various exemplary embodiments herein solve the problem whereby a virtual content author (i.e. a user) has only a single current GPS location but wishes to place virtual digital media objects around that real-world location. For example, even if the current GPS accuracy is to within 10 metres, this method would allow for the placement of one or more virtual digital media at any discreet distances relative to that GPS location. Furthermore, the virtual digital media should be perceived as persisting in the same AR space, relative to visual real-world reference points, as the original placement was intended by that user. This solution achieves this across a variety of devices and various real world environmental variables. It also allows for the accurate placement and consistent viewing of multiple digital media that have been placed in close proximity to each other with the intention to appear as a single object as illustrated in FIG. 3.

To achieve these results, various exemplary embodiments can:
track a user's movements precisely and smoothly in the real world.
allow users with different equipment to accurately solve for the same position accurately and repeatedly.
eliminate drift in the positions of digital media that might otherwise occur if simple raw GPS data were to be used to identify locations.
provide sub-meter accuracy from software running on a variety of devices where raw GPS measurements are typically within accuracies of 3+m (1−sigma) in horizontal and 10+m vertical.
achieve consistent results across variables including:
different GPS sensors that have different chipsets, noise profiles, data rates, and accuracies and exposure of helpful satellite data (e.g. GNSS raw data).
different sensors such as, but not limited to: accelerometers and barometers that may produce different data or datasets, and have varying availability and update rates.
satellite constellations that vary over time (e.g. 12 hour orbit, not a fixed pattern) and in varying availability in satellite quantities.
effects of weather (local and atmospheric) on GPS data.
effects from urban, land canyon, and foliage
different operating systems and versions offering variable location support and precision.

Some aspects of exemplary embodiments include:

Obtaining an initial reference position at which to:
anchor digital media relative to.
view existing digital media relative to.

Performing fine grain motion tracking over time, to predict the most accurate location given a variety of variables including, but not limited to: loss of GPS signal, infrequency of GPS signal, and sudden changes in environment or movement.

Calculating the most accurate location where digital media is placed.

These are discussed in further detail throughout this specification.

### ADDITIONAL NOTES

Example coordinates provided in the figures within this patent specification are for demonstration purposes only and don't necessarily reflect values that may be encountered or calculated in the real world.

Various exemplary embodiments described herein play a key role in the placement and viewing of Media Tags in AR and VR environments. For more information see U.S. Non-Provisional application Ser. No. ______ filed on May 18, 2017, titled “Media Tags Location-Anchored Digital Media for Augmented Reality and Virtual Reality Environments.”

### Assumptions and Terminology

Augmented Reality (“AR”): a digital system or interface through which the user can view their surroundings with augmentations of that view. Any discussion of AR or related aspects of it refers to augmentation of a real world or “AR” environment. An AR platform creates a virtual graphics coordinate space that coincides with the real-world space around a user and renders computer graphics relative to that virtual graphics coordinate system such that those graphics appear to exist in the real world. An appropriate viewing device is also assumed for the user, such as but not limited to: a head-mounted display (e.g. augmented reality glasses or goggles) or a smart phone (i.e. acting as a viewing portal that displays computer graphics on top of, or blended with, a live video feed of the world as seen by camera hardware embedded in the device).

Virtual Reality (“VR”): a virtual reality platform creates a virtual graphics coordinate space into which computer graphic content is rendered in such a way that when viewed through a viewing device, all the user sees are computer graphics. No real world objects are seen in this environment. Appropriate viewing and interaction devices are also assumed for the user, such as, but not limited to: head-mounted displays, optionally with body or body-part motion tracking sensors and software, smart phones (i.e. acting as a viewing portal that displays computer graphics on top of, or blended with, a computer graphics environment background).

Accuracy: in a geographical context, accuracy is how close we can identify a location to its actual real location. For example, a user may be located halfway between addresses 41 Main Street and 42 Main Street in reality, but due to limitations in accuracy, mapping software may only be able identify the user as being in the 4000 block of Main Street.

Precision: in a geographical context, precision is how fine one can pinpoint a location on a map. In terms of GPS coordinates, generally more decimal places in the latitude and longitude components offer more precision. For example, as an analogy, placing a pin into a paper map to identify a location is much more precise than circling that location with pen.

Filter: a method such as a mathematical process that takes one or more inputs and produces an output. In the context of various exemplary embodiments, a filter may be used to convert data from multiple inputs (e.g. GPS sensors) and sources (e.g. historical data) to a more accurate form. A filter may optionally take input from one or more filters and/or send its output to one or more filters.

Fusion: the process of using data from multiple sources to produce an output (e.g. using GPS and acceleration data to derive a very precise location). Fusion may involve the usage of one or more mathematical filters as well as historical data to analyse the input and produce a more accurate output.

Media Tag or Tag: a digital media element that a user can place at a location to attach information to that location. See the [Media Tag patent spec] for additional information.

Client Device: a device used by a user to place and view digital content in an AR or VR environment.

Digital Media Software: software running a client device which provides the functionality to place and view content in an AR or VR environment.

Viewport: the field of view provided by the client device.

AltitudeASL or ASL: altitude above sea level. A common measurement of elevation relative to sea level.

Callback: in software engineering, a callback is a function or method registered for invocation by another entity (e.g. the OS) so that the software can be notified about an event (e.g. a particular method to be called automatically when the device senses it has changed location).

Application Programming Interface (“API”): in software engineering, an API is a set of functions, methods, or other interface components through which software entities can exchange digital information.

Instantaneous Location: a location obtained by using only the most up to date location information available on the client device. Note that this could include usage of historical data.

Continuous Location: the process of collecting location information over time and using that information to improve the accuracy and reliability of future location information.

East North Up (“ENU”): a Cartesian space coordinate system in which a position is represented using coordinates along axis' corresponding to east (X) and north (Z), while the “up” (Y) axis indicates the elevation. In the context of this patent specification, an ENU coordinate system refers to the computer graphics coordinate space whose origin is located in the real world at a specified GPS location. ENU is well suited to various exemplary embodiments herein because it provides a location which can be correlated to a real world GPS position, while the “up” component can store an elevation.

Land Canyon: environmental elements such as buildings which limit the line of sight angle(s) between a client device and GPS satellites in the sky.

Initerial Measurement Unit (“IMU”): a sensor capable of measuring real world data (e.g. an accelerometer or gyroscope).

Geocoordinate: a coordinate representing a real world location, typically comprised of latitude, longitude, and altitude.

Computer vision techniques: methods which identify specific patterns as viewed through a client device, which are then replaced with computer graphics content. Such techniques represent an alternative approach for placing digital media in an AR world.

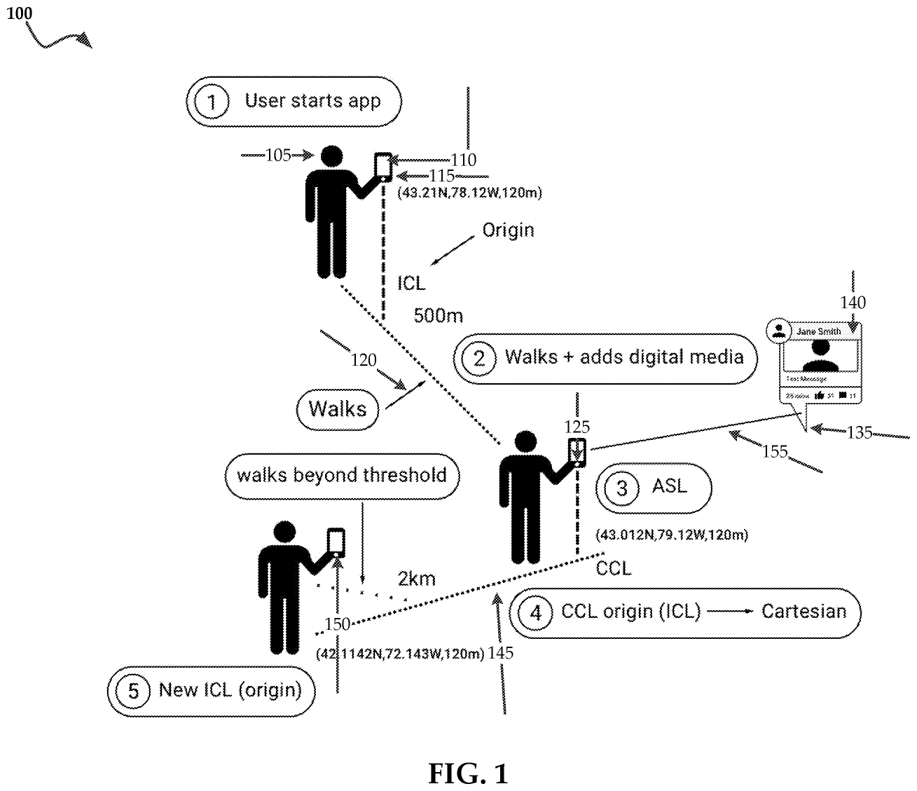

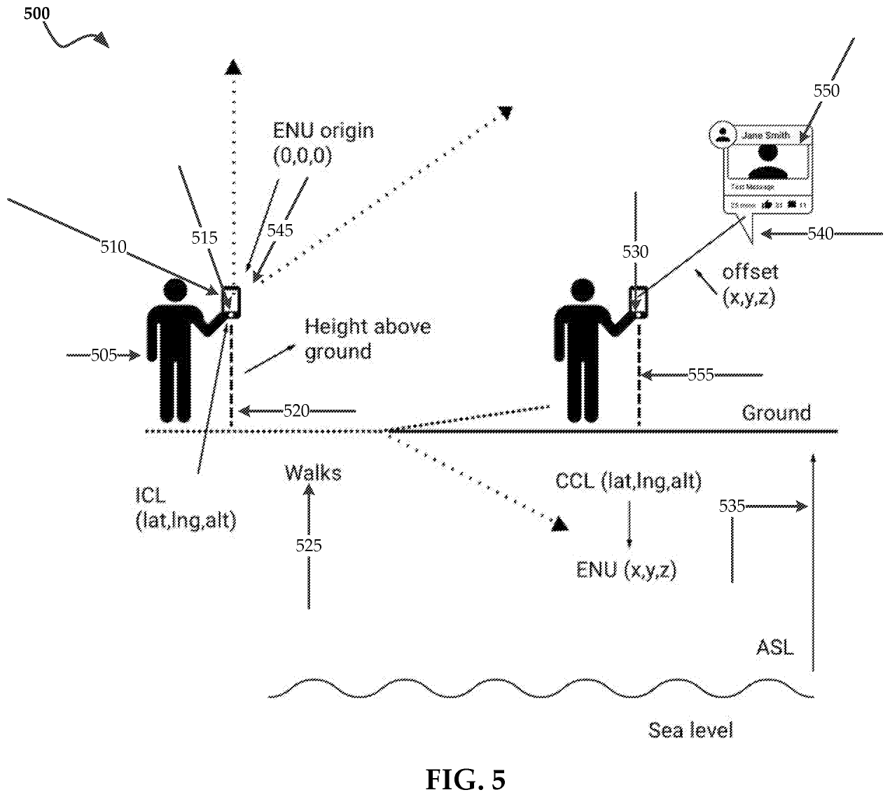

FIG. 1 provides an exemplary overview diagram 100 of a user 105 with a client device running digital media software 110. Note that all coordinate values in diagram 100 are contrived for demonstration purposes and don't necessarily reflect real values. The user's initial course location 115 consists of GPS coordinates 43.21N, 78.12W, and an ASL of 120 m, and is recorded by the digital media software on the client device 110 as the reference origin. This reference origin will be used as the location that the placement of digital media will be relative to (details on this placement are provided in the description below corresponding to FIG. 5).

Determining an initial location may involve a process to derive the most accurate location possible. For example, it may be necessary to wait for a “stable” location by analysing a number of location updates provided by the client device 110 and then running a process to determine which of those locations is the most accurate. This can be achieved using a variety of methods, such as, but not limited to, the following set of steps:
cleaning up the GPS coordinates received from the client device.
ignoring outlier positions (i.e. ignoring locations that lie outside the range of the majority of coordinates).
ignoring glitches in GPS data (e.g. sudden spikes in coordinates due to noise).
ensuring the chronological order of GPS data is correct (e.g. sometime GPS data may arrive out of order (older before newer).
averaging GPS locations to ensure the user is not moving around, or to eliminate those related to user movement.

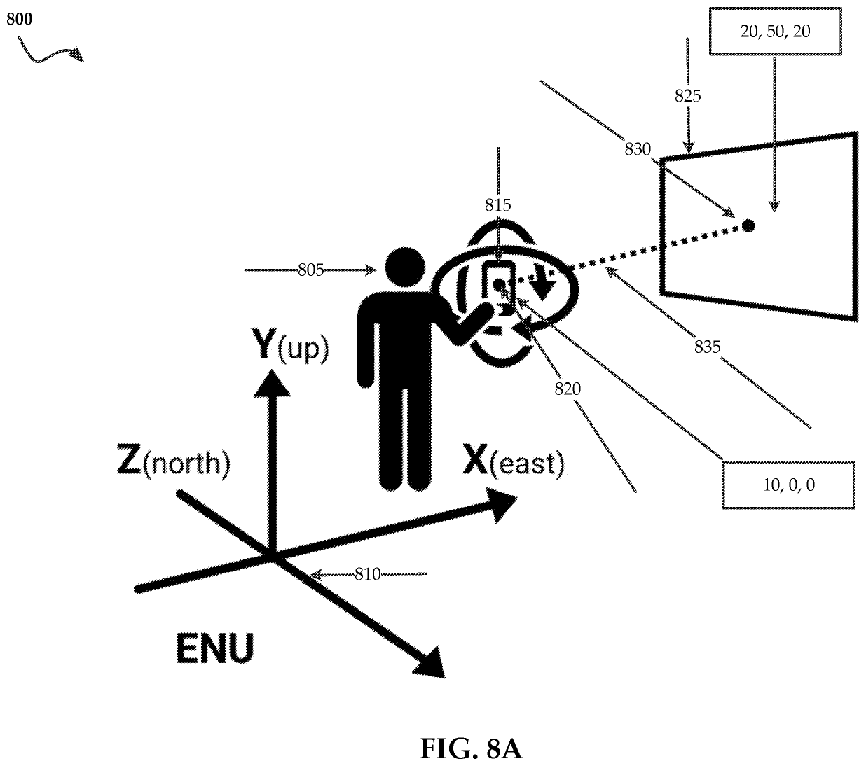

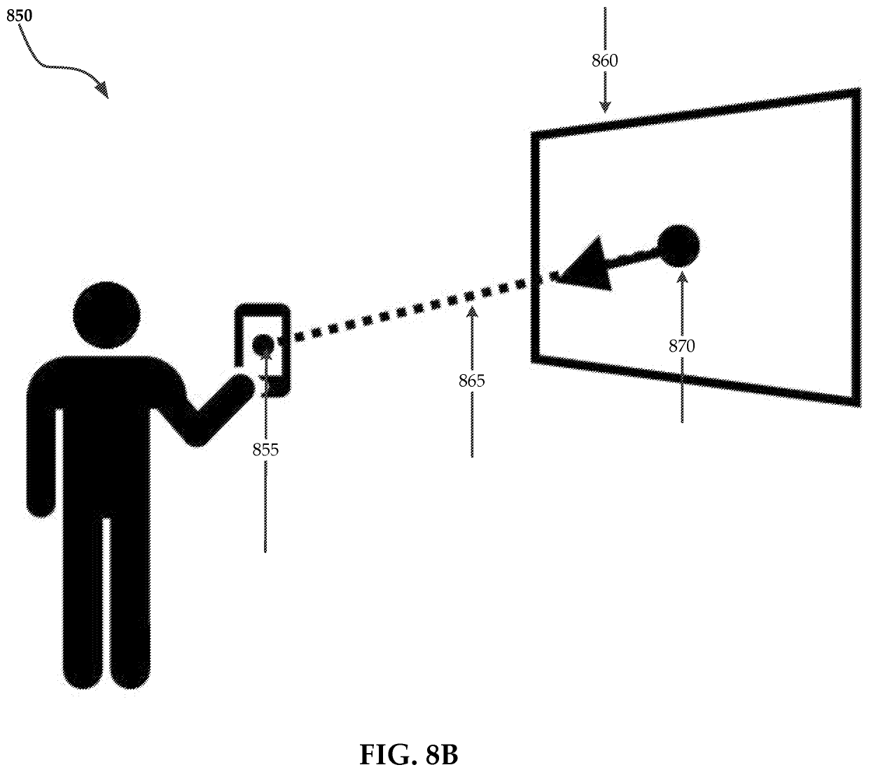

The user then walks a certain distance away 120 from their initial course location 115, then stops and points their client device 110 at a point of interest 135. They then take a picture of this object of interest, record a video of it, and/or enter a text comment, and place digital media 140 at the point of interest. The location for that point may be calculated as the user's current course location 125, plus a 3D offset 155 from that location. Current course location 125 consists of GPS coordinates 43.012N, 79.12W, and an ASL of 120 m. The orientation of the digital media 140 may also be calculated and stored so that it always appears in the same orientation as when it was placed, when viewed in the future or by other users. Additional details on calculating orientation are provided below in the description corresponding to FIG. 8A, and FIG. 8B.

The user then continues to walk in another direction 145. Once they pass a certain threshold distance (e.g. 2 km) from their initial course location, the digital media software on the client device 110 may then record that position 150 as a new initial course location to use as a reference point. Since the Earth is not a perfect ellipsoid, updating the reference origin every so often such that locations for digital media placement are proximal to their reference origin, helps to prevent the increasing mathematical error in calculating the placement location that would occur if the reference origin was never updated.

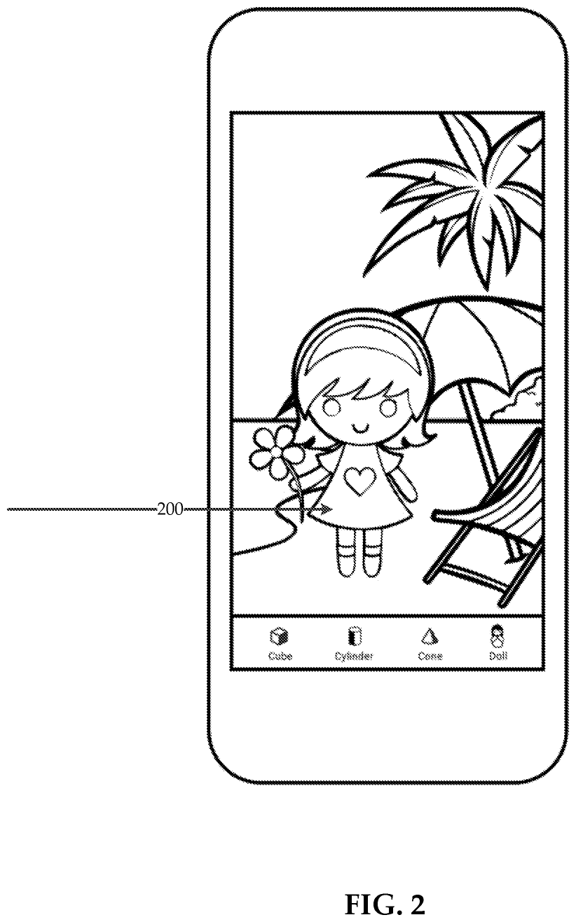

FIG. 2 provides an exemplary example of digital media software on a client device 110 which is displaying a computer graphic doll 200 that has been placed in an AR environment at a precise location.

FIG. 3 provides an exemplary example of digital media software on a client device 110 which is displaying multiple digital media objects 300 that have been placed into AR environment to appear as if they form a single object. This example further exemplifies the importance of precise and accurate location calculations for objects. Although the objects 300 in FIG. 3 are separate objects, they have been placed in such a way that collectively, they appear as a single object constructed of multiple shapes. Thus precision placement and orientation are critical to ensuring that the objects 300 appear as they were originally placed, regardless of the client device being used to view them. Other factors such as, but not limited to, the elimination of GPS and sensor drift, are also critical for ensuring correct placement, particularly for multiple objects that must appear as one like those in FIG. 3.

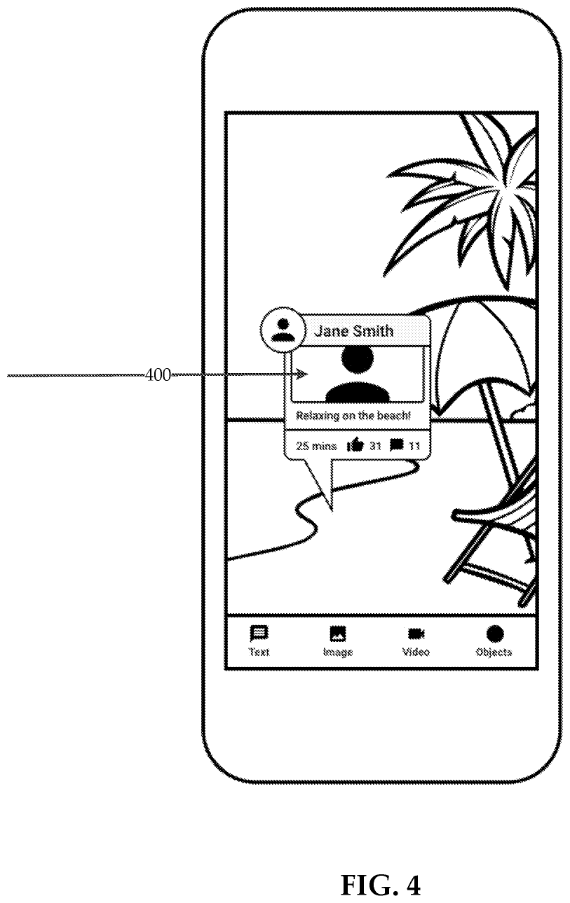

FIG. 4 provides an exemplary example of digital media software on a client device 110 which is displaying a Media Tag 400 that has been placed in AR environment at a precise location. For additional information about Media Tags see U.S. Non-Provisional application Ser. No. ______ filed on May 18, 2017, titled “Media Tags Location-Anchored Digital Media for Augmented Reality and Virtual Reality Environments.”

FIG. 5 provides an exemplary conceptual example 500 with greater detail about the placement process. In example 500, a user 505 is navigating and then placing a Media Tag in an AR environment. The user 505 starts an “initial location” 515 determined to be at the GPS coordinates of their client device 510 and at a height calculated as the ASL 535 plus an offset 520 from that ASL. The purpose of offset 520 is to allow for the calculation of the device's ASL because the typical altitude information obtained represents a ground level ASL, where as user's are typically using (e.g. holding) their device while standing. This offset may be user configurable or fixed. An example of the latter might be to choose a “typical” height at which a person holds their client device 510 above the ground, so that the digital media software running on the client device 510 always assumes that height above ground level.

This real world location is then recorded as the user's initial location 515 and the digital media software running on the client device 510 records this as such. It also creates a virtual ENU coordinate system 545 where by the origin of this ENU coordinate system 545 is located in the real world at the initial location.

The purpose is to represent real world spherical (i.e. Earth) coordinates which are indexed by latitude, longitude, and altitude, into a three axis linear reference system, typically a Cartesian coordinate system that can represent a position in a computer graphics environment. While ENU is one linear reference coordinate system that can be used, any suitable linear coordinate system may alternatively be used such as but not limited to, one which represents west on the X axis, south on the Z axis, and up on the Y axis, for example.

The user 505 then navigates 525 in the world arriving at a new GPS location 530, possibly with a change in ASL. This location is referred to as their “current course location”. The user chooses to place digital media 550 (e.g. a Media Tag) at some offset 540 relative to them when standing at their current course location 530, based on the yaw, pitch, and/or roll of their client device 510. The purpose of offset 540 is to allow the user to specify the placement of digital media relative to their location. This is particularly useful when a user is unable to physically position themself close or near to the point of interest that they wish to add digital media to.

Note that logic may optionally be included in the digital media software to assist the user in the placement of digital media such that the user can see a reasonable level of detail when placing the digital media. For example, the digital software may enforce a minimal proximity to the user to prevent them from placing the digital media too close which would obfuscate the viewport of the user's client device 510, resulting in a poor user experience.

The offset in front of the user 540 may consist of user configurable or fixed distance value(s) provided by the system. For a user configurable offset, the user may be provided an appropriate user interface within the digital media software running on the client device 510, allowing them to visually place this location. For example, a user may be provided with an icon on their client device's touch screen display, allowing them to “nudge” the offset in front of them.

The current course location 530 is recorded by the digital media software on the client device 510 as the GPS location of the client device 510, as well as its height, which is calculated as ASL 535 plus offset 555. This location may then be input into a filter (e.g. Kalman filter) and optionally fused with data from other sensors such as, but not limited to: accelerometer, barometer, and historical GPS data, to estimate a true, accurate position in ENU coordinate space 545.

The calculation of the true position in ENU coordinate space 545 can be performed using a variety of methods including, but not limited to, the following formula:

$$Position X = ( Current Longitude - Current Longitude ) * 111319.4917 * Cos ( Origin Latitude * 0.0174532925 )$$

$$Position Y = Current AltitudeASL - Origin AltitudeASL$$

$$Position Z = - ( Current Latitude - Origin Latitude ) * 11133.3333$$

where by:

The current longitude and latitude and current AltitudeASL are the user's GPS location and altitude which are to be converted to ENU space.

The origin longitude and latitude and the origin AltitudeASL are the GPS location and altitude of the reference origin.

The Position (X, Y, and Z) calculated by this formula is the position in ENU coordinate space.

The Earth's circumference through poles is assumed to be 40008000 m and the Earth's circumference at the equator is 40075017 m.

The digital media software on the client device 510 provides an appropriate user interface on its viewport to show and possibly allow for user adjustment of the offset 540 in front of the user at which the digital media will be placed. Once placement at that location is confirmed by the user, the digital media software on the client device 510 then stores this offset from the user's current location, and the user's current location itself.

The heading, yaw, pitch, and optionally roll of the client device 510 may also be captured by the digital media software on the client device to record the orientation of the digital media being placed. These can be used to control the azimuth and vertical position of the digital media. Further details about this are provided below in the descriptions corresponding to FIG. 8A and FIG. 8B.

The client software now has everything it needs to serialize for the digital media so that it may be accurately placed by an author and viewed by other users. This includes, but is not be limited to:

The location (GPS and altitude) of where the user was when they placed the digital media in the world (more specifically that of the client device 510).

The world offset of the digital media within the ENU coordinate system 545, whereby the ENU coordinate system's origin is located at the user's initial location 515. The world offset is calculated by adding offset 540 to the user's location 530 to provide an offset relative to the ENU coordinate system's origin. Since the world offset is relative to ENU coordinate system's origin, its value may be relatively small (e.g. from within a few meters to 100 meters). Hence the importance of continually updating the initial location as the user navigates over wider distances, so that the numbers used in calculating these world offsets remain fairly small and thus reduce or eliminate any loss of precision which would have been encountered with very long distance world offsets. More generally these world offsets are “anchored” to a known location, such that the placement of multiple objects (e.g. those in example 300) can be accurately reproduced in a viewport to ensure they look the same as when they were placed.

(Optional) The orientation of the digital media. May be used by the digital media software to reproduce the orientation of the digital media when viewing it. This may also be important when placing multiple objects to appear as one (e.g. those in example 300).

Note that the process for anchoring the ENU coordinate space at a GPS location, and more generally, converting GPS coordinates to ENU coordinates may only apply to AR environments. VR environments already exist in Cartesian based computer graphics coordinate spaces and generally have no GPS coordinates to convert from.

Note: for additional information about serialization and other aspects of the digital media software on the client device 510, see U.S. Non-Provisional application Ser. No. ______ filed on May 18, 2017, titled “Media Tags Location-Anchored Digital Media for Augmented Reality and Virtual Reality Environments.”

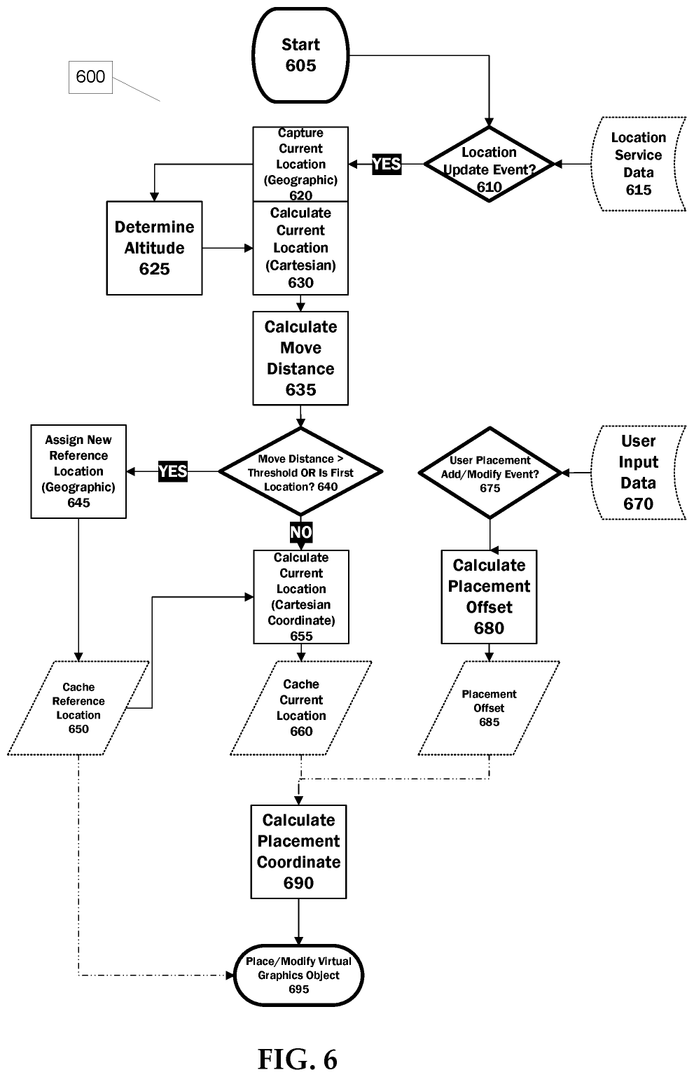

FIG. 6 illustrates an exemplary process 600 that digital media software might use for calculating placement of digital media in an AR environment, such as in example 500.

The software is started on the client device 605 which checks for the user's initial course location. This location may come from a location update event 610 (e.g. a callback within the digital media software which is invoked from the client device's operating system) which may expose location service data 615 that is available on or to the client device. The location service data 615 may include data from a variety of sensors on the client device 605 such as, but not limited to: GPS sensor, accelerometer, and barometer. The location service data 615 may be frequently updated by the software and/or client device, causing subsequent location update events 610 to occur.

Location service data 615 which may originate from the client device, may consist of data from multiple sources that has already been fused by the client device or operating system such as, but not limited to: information from GPS satellites, WiFi, and/or cellular towers. Thus node 610 and other components of a system like example 600 may need to be programmed to work with raw or fused data. Note that fused data from the client device may provide a quick way for digital media software to obtain a course location while the device is obtaining a satellite fix.

The location update event 610 may optionally perform fusion from multiple types of data such as, but not limited to: GPS coordinates, GPS speed, altitude from a lookup service, and acceleration. The location update event 610 may also optionally perform filtering on the data. The output from location update event 610 is an accurate location in ENU coordinate space. Note that the digital media software may convert this output back to geo coordinates (e.g. latitude, longitude, and altitude) for storage purposes.

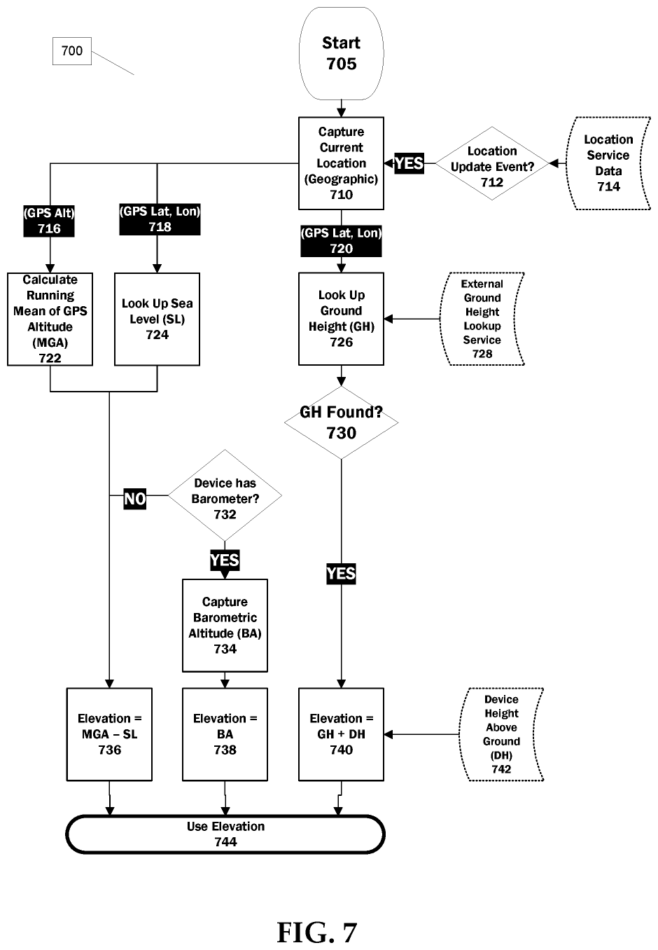

Once a location event 610 has provided a location, the GPS coordinates are recorded by the software as the user's current course location 620. The user's altitude 625 is then determined using an appropriate method (see the description below corresponding to FIG. 7 for additional information on determining height). The GPS coordinates of the current location 620 along with the altitude 625 are then converted to ENU space 630. If an initial course location has not already been obtained, then an initial course location will be determined and thus will form the location for the origin of ENU coordinate space 630. The initial course may be determined using a variety of methods to account for issues such as, but not limited to, GPS satellite stabilization. An example of such a method is to take a number of locations provided by location update event 610 and from those, choose an average location weighted by accuracy as the initial course location. The location may be stored by the digital media software as a geocoordinate. If a previous location already exists, then the distance between the current location and the initial course location is calculated in sub process 635.

A check 640 is performed to see if this distance is greater than some threshold or if an initial course location needs to be determined. If either condition is satisfied in check 640, then the GPS coordinates and altitude for the current course location are stored as the reference location 645 where the origin of the virtual ENU coordinate system will be placed at, in which case the GPS coordinates and altitude for this reference location 645 are cached 650 by the software. If both conditions for check 640 are not satisfied, then the GPS and altitude for the current location are converted 655 to a coordinate in the virtual ENU coordinate space, after which the software caches this ENU coordinate 660.

Using an appropriate user interface, a user may provide input 670 resulting in event 675 indicating the user's intention to add or modify digital media at their current location. The digital media software then calculates a placement offset 680 (3D vector) in ENU coordinate space based on the direction in which user's client device is facing (e.g. a position two meters in front of the user's client device, which the user is looking at through their device's viewport). The distance in front of the user may consist of user configurable or fixed distance value(s) provided by the system. The calculation 680 may also factor in the yaw, pitch, and/or roll of the user device's orientation.

The software then calculates the final placement coordinate 690 in the virtual ENU coordinate space, which is relative to the origin of this coordinate space. It may do so by adding placement offset 685 to the cached current location 660 to determine placement coordinate 690.

Final placement of the digital media 695 may involve caching numerous pieces of data such as, but not limited to: the GPS coordinates/altitude of the cached reference location 650, the virtual ENU coordinate space coordinate 690, and optionally, the orientation at which to place the digital media (not shown in flowchart). The digital media software may optionally store data to the server such as, but not limited to: the geocoordinates of the authoring user, the ENU space offset to the digital media, an orientation vector for the digital media, and information related to the digital media itself (e.g. comments, images, etc.). The software can now accurately and consistently display the digital media at the placement location in the real world. Such data may then be used to reconstruct the digital media object at the exact location where it was placed (e.g. when another user views it through their client device with digital media software).

FIG. 7 illustrates an exemplary process 700 for calculating a user's height/elevation. Calculating accurate elevation is essential for performing accurate placement of digital media in an AR environment. However, altitudes derived from GPS are well known to have a best case accuracy of about 1.5 metres-three times worse in accuracy than their horizontal position accuracy. In addition, online lookup services at a particular latitude/longitude may have inconsistent levels of accuracy due to the multitude of technologies used to initially obtain the data. Therefore a procedure may be required to help achieve a more accurate altitude measurement for a given location such as that illustrated in procedure 700.

The digital media software is started 705, and the current GPS coordinates are captured 710 from the client device. When starting, the digital media software may calibrate the client device's compass to ensure it provides the most accurate location data possible. As the user continues to use the client device, periodic location update events 712 (e.g. callbacks in the digital media software invoked from the client device's OS) may occur to provide updated GPS locations using location service data 714 available on or to the client device.

The latitude and longitude 720 of the current location 710 are then input to a ground height look up process 726, which may utilize an external ground height lookup service 728 (e.g. communicating with a web based ground height lookup service through an API) to obtain the known elevation at that GPS location based on known geographical data. Note that the digital media software may utilize one or more external ground height lookup services 728 for various reasons including, but not limited to: availability at a given location or choosing a service with the required level of accuracy.

The latitude and longitude 718 of the current location 710 are also input into a process that looks up the mean sea level offset 724. For example, input may be with respect to the WGS84 datum's ellipsoid for which node 724 converts the offset to a more accurate form such as an EGM96 datum. Offsets to translate altitude into the EGM96 datum may be pulled from a table stored in the client device's memory or from a lookup service of some sort.

The GPS altitude 716 is input into a process 722 that calculates the running mean of GPS altitude. An elevation is then calculated 736 by subtracting the output of the sea level lookup 724 from the running mean GPS altitude 722. This is input into a process 744 which calculates a final, relatively precise elevation by fusing elevations from multiple sources.

The ground height look up process 726 may or may not be able obtain a ground height value for a variety of reasons such as, but not limited to, availability of Internet connectivity.

If check 730 indicates that ground height look up process 726 was able to obtain a ground height, the value is then input into a process 740 which calculates the device's elevation (altitude) by taking the ground height value from process 726 and adding to it, the device height above ground 742. The device height above ground 742 may be derived using a variety of methods such as, but not limited to, simply using a fixed value above ground which represents a typical average height at which users hold their client devices. The result of the calculation performed in process 740 is the absolute altitude at which the user's device is currently located, which is then input into process 744. If check 730 indicates that ground height look up process 726 was not able to obtain a ground height, then process 740 will not be invoked and therefore sub process 744 will not receive input from process 740.

The software may perform check 732 to see if the client device has a barometer from which an altitude for the client device may be obtained. If check 732 indicates the availability of a barometer, then a process for capturing the barometric altitude 734 is invoked by the software and the resulting barometric altitude 738 is then input into sub process 744. Since a barometer my not be calibrated, process 734 may need to perform this task. There are a variety of methods of calibrating a barometer such as, but not limited to: using the device's current location to locate the nearest weather stations and interpolate/extrapolate a mean sea level atmospheric pressure at the current location.

Sub process 744 uses elevations calculated from one or more sources from throughout process 700. An elevation from process 736 will always be available, whilst an elevation from process 738 or 740 may or may not be available depending on the conditions in checks 730 and 732. If more than one elevation input is available, process 744 “fuses” these inputs to provide the most accurate elevation possible. It should be noted that all three potential elevation inputs to process 744 are altitudes.

Note that process 700 may only apply to AR environments. VR environments are generally already in a Cartesian based computer graphics coordinate space whereby the height of a user is typically generated and known by the digital media software.

FIG. 8A and FIG. 8B provide exemplary examples 800 and 850 respectively, showing aspects of how the orientation of a user's client device may be used to calculate the orientation of digital media (e.g. a Media Tag) when placing it in an AR or VR environment. Note that this calculation is assumed to be using coordinates from a 3D computer graphics space (i.e. Cartesian coordinates). In the case of AR, this calculation would take place in a virtual ENU graphics space where by the ENU coordinates of the user's location are known, as are the offset from the user to the look at point (i.e. this calculation would take place once the user's location is converted from real world GPS coordinates and altitude).

Example 800 shows a user 805 located in ENU space 810 at location 10, 0, 0. The user 805 is holding a client device 815 (e.g. smart phone) which provides a viewport through which they can observe the world. The client device 815 is running digital media software allowing the user to place and view digital media. Through the viewport of client device 815 the user is looking at a point of interest 830 and decides to place digital media 825 at that location. The digital media software calculates the 3D point in space in front of the user by taking the user's current location 820 and adding an offset 835 in front of the user at which to place the digital media. In this example, the final calculated point 830 is at ENU coordinates 20, 5, 2, relative to the ENU origin. In other words location 830 is the absolute placement position within the virtual ENU coordinate space.

Example 850 shows how a normal 865 for the digital media 860 may then be calculated to represent the orientation of digital media. By subtracting the user's location 855 from the calculated point of interest 870, the resulting vector can then be normalized to form the digital media's normal. One or more components of this normal may then be adjusted if necessary. For example, the normal 870 could be inverted so that its X, Y, and Z coordinates are negated to capture the fact that the digital media is facing towards the user's client device. The final normal 870 may then be cached and or stored along with other digital media data.

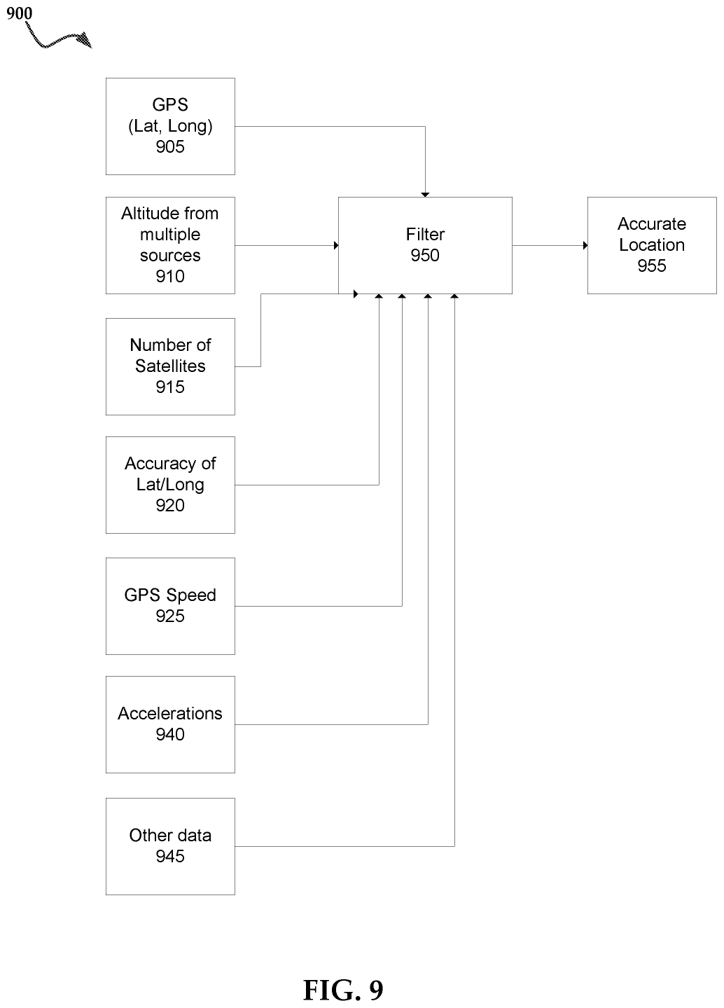

FIG. 9 is a block diagram of an exemplary example 900 showing nodes that may be involved in performing filtering. Nodes 905 through 940 represent some, but not limited to, the types of sensors which may be present on a client device which can provide data to a filter 950 that can fuse these inputs together to obtain a more accurate location. By combining and analysing data in such a manner, filter 950 may be able to best estimate locations which are more accurate than consuming just GPS and altitude data alone.

Data which may be input into a filter 950 may include, but is not limited to:
GPS data 905.
altitude data from multiple sources 910.
the number of GPS satellites 915.
the known accuracy of the latitude and longitude 920.
GPS speed 925.
accelerations 940.
other data 945. Other data may include, but is not limited to: historical data and data from other IMU sensors.

Filter 950 is a system which can be implemented in a variety of ways. Such a filter might make use of one or more mathematical processes or “filters” such as, but not limited to: Kalman filter, high/low pass filter, complementary filter, to produce a more accurate output from the fusion of given inputs.

The output from filter 950 is location information 955 that should be more accurate than that provided in nodes 905 and 910. Note that filter 950 may optionally create and reference its own historical data in the process of performing filtering.

The acceleration data 940 and GPS speed 925 allow precise offsets of movements between GPS updates to be obtained and provides a more accurate absolute location than GPS alone. For example, consider the following events: a second GPS update event received by the digital media software indicates that the user is 10 meters west of that from the first GPS update, but with an accuracy of +5 meters. However, the accelerometer data received indicates that the user only moved 6 meters west while the GPS speed data indicates a distance of 7 meters west. By having a filter that can use all of the error profiles of these three sources, filter 950 can now best estimate a user's location and the degree of probability that that location is the true location of the user.

The location filter 950 may perform filtering operations on latitude, longitude, and altitude data. For example, a filter can take advantage of barometric altitude and the elevation lookup data to best estimate a more accurate altitude.

Similarly, filter 950 could generate a more accurate orientation. For example, a magnetometer (compass) provides an absolute orientation but is affected by local magnetic sources. A gyroscope however, isn't affected by these local sources and is very accurate; however it gives rotational rates, not an orientation. These rotational rates however can be integrated to get a noisy, but still helpful change in rotation which can be used to smooth out the noise in the magnetometer.

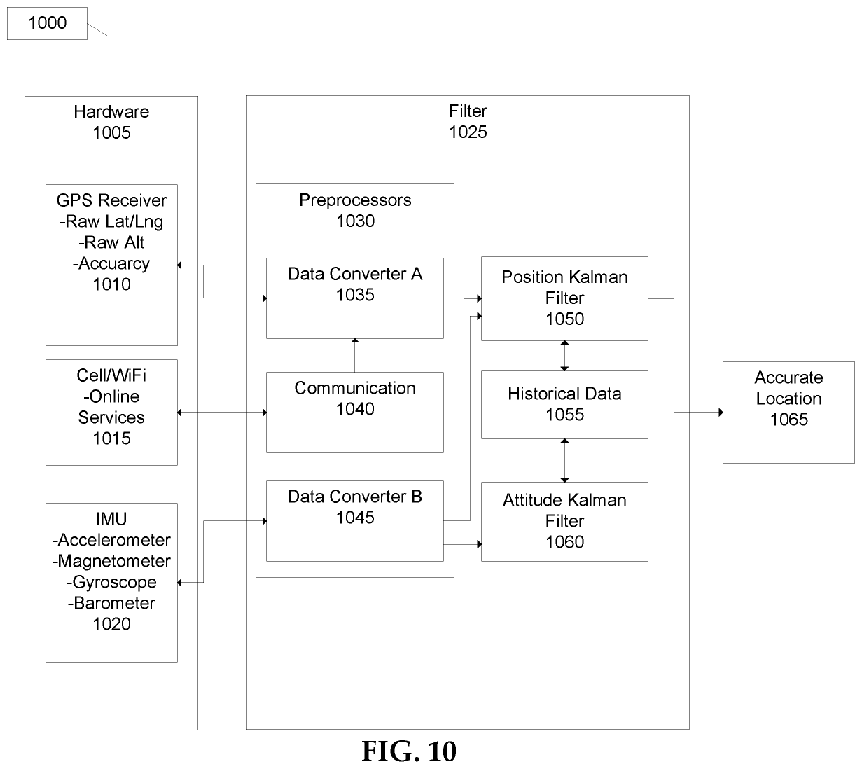

FIG. 10 is a block diagram of an exemplary example 1000 which shows a possible overview of how a filter might be implemented. This filter may be compiled as part of digital media software or into a standalone library which can be linked or dynamically linked with and used by the digital media software. A filter may rely on other software components and libraries (e.g. open source math libraries).

Filter 1025 performs the fusion process and may work on the premise that knowing both previous and current velocity, acceleration, and optionally other data about a user can improve the accuracy in determining the current location. Filter 1025, or one very similar to it, may be used whenever the digital media software acquires a new location (e.g. during continuous movement) or when acquiring an initial location on start up. A filter may be composed of a number of sub components and sub filters, including preprocessors 1030. In example 1000, filter 1025 consists of all of the sub nodes depicted as being within node 1025.

Capturing a location can take place both when the user is idle (e.g. when they first boot up their client device or remain stationary at a location), and while they are moving (e.g. they walk a certain distance from their previous initial course location). The former case can be considered a situation where “instantaneous” location data is required, while the latter may involve “continuous” location tracking to maintain precision.

Note: filter 1025 and other aspects of digital media software may also run when the digital media software is idle (e.g. running in the background on the client device). This may be used to continually gather historical data 1055 for future calculations.

Digital media software may also optionally turn off certain features such as, but not limited to, the GPS receiver, when the software is idle. Alternatively digital media software may choose to request which underlying sources of data should be used to provide location information. For example, using location data derived from WiFi/cellular towers may be beneficial in situations such as, but not limited to:
when power savings on the client device are necessary even though location accuracy may be reduced. This would require that the GPS receiver on the client device be shut down to conserve battery.
when the user doesn't wish that his precise location be known.

Similarly, the client device and/or its OS may provide fused data from WiFi/cellular towers in situations such as, but not limited to:
when satellite coverage is poor.
during start up when the GPS hasn't got a good fix yet.

Both instantaneous and continuous movement cases present a number of challenges in obtaining a very accurate and precise location. For example, current smart phone GPS technology has a typical accuracy rating of ˜3 m for consumer devices which means that the diameter of inaccuracy potential is ˜6 m (this is a best case with current technology and still only provides around a 68% confidence level of being within this diameter). By employing a filtering process like that depicted in example 1000, a digital media system may be able to overcome problems and address issues such as, but not limited to:
achieving a more accurate location than that provided by GPS sensor data alone, both at idle and when moving.
predicting the user's location when GPS data is not available (e.g. when there is a lack of Wi-Fi or cellular signal, and/or when the user is out of sight from GPS satellites).
variations in noise and drift across different user devices.
adjustments for noise due to sudden behavioural changes of the user (e.g. the user suddenly speeds up).
variations in the types of GPS data provided on a given user device (e.g. data may include, but is not limited to: position, bearing, speed, or sometimes both).

GPS multipath mitigation (i.e. lessening the impact of errors caused by multipath GPS signals, typically those caused by canyon effects).
weather conditions.
acceleration offset bias and GPS drift.
differences in data update frequencies between GPS peripherals and accelerometers on a given user device; typically, GPS systems update much slower than accelerometers. As such, the drift/bias must be continually integrated between these two data sources that are updating at different speeds.
adjustments for GPS satellite constellation changes.
GPS Doppler speed resolutions reported by GPS chipsets.
exposure of GNSS raw measurements by the operating system.
bearing and course accuracy fused with accelerometer accuracy.
bounding the accelerometer drift and integration errors from the GPS.
fusing in known dynamics (e.g. people don't accelerate randomly while using the application) as pseudo measurements.
smoothing data to overcome hardware biases (e.g. an accelerometer not perfectly aligned with the camera's chassis) along the X, Y, and/or Z axis.

The hardware components listed in node 1005 are some of the many components that may be available on a client device to provide data to filter 1025. This could include, but is not limited to:
GPS Receiver 1010—provides raw latitude, longitude, altitude and possibly other GPS information such as, but not limited to: accuracy information and speed.
Cellular/WiFi Radio 1015—provides access to online services such as altitude lookups.
IMU 1020—other sensors such as, but not limited to, accelerometer etc.

In example 1000, data from GPS receiver 1010 is input into data converter A 1035 which converts it into a form expected by the position Kalman filter 1050 (e.g. data converter A 1035 might output WGS84 compliant values that the Kalman filter has been programmed to process). The data output from filter 1035 is then input into the position Kalman filter 1050 which performs GPS and altitude filtering. Position Kalman filter 1050 may cache this information as historical data 1055 and then read that historical data 1055 when performing future filtering operations.

The cell/WiFi radio 1015 may be used to provide access to online services such as elevation or location lookups. A communications subcomponent 1040 of the filter, may communicate with these services through the cell/WiFi radio 1015. Data received may be input into data converter A 1035 which can convert it into a form expected by the position Kalman filter 1050.

Node 1020 lists some of the possible IMU sensors that may be present on a client device. Additional data from IMU sensors such as those listed in node 1020 may also be utilized by filter 1025. A separate data converter such as data converter B 1045 may be necessary to convert the IMU data into another form expected by a Kalman filter. In example 1000, data converter B 1045 outputs data which is then input into both the position Kalman filter 1050 and the attitude Kalman filter 1060. Output from data converter B may include data such as, but not limited to: accelerations, magnetometer data, and angular rates.

Attitude Kalman filter 1060 fuses data such as that from an accelerometer, magnetometer, and gyroscope to produce accurate yaw, pitch, and roll data. Attitude Kalman filter 1060 may save and/or read historical data to produce an output.

Filter 1035 then fuses the output from the position Kalman filter 1050 and the attitude Kalman filter 1060 to produce a final accurate location 1065.

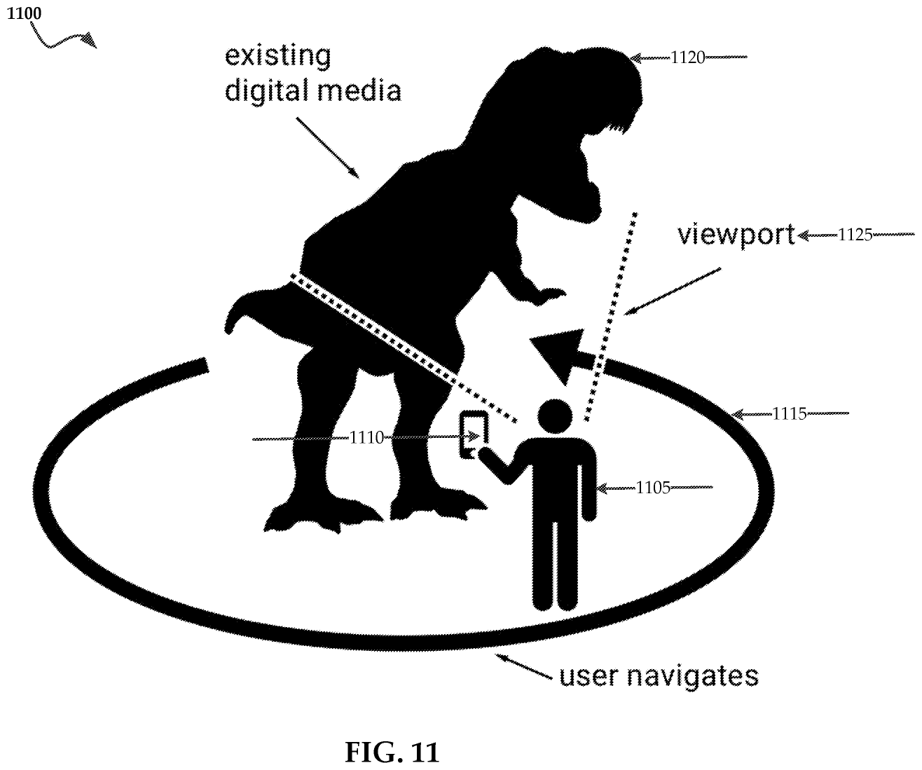

FIG. 11 provides an exemplary example 1100 showing a user 1105 navigating an AR world. In example 1100 user 1105 is viewing a 3D digital media object 1120 that has been placed in the world, through the viewport 1125 of their client device 1110. The client device 1110 has digital media software that utilizes all of the methods provided throughout this specification to perform this viewing as user 1105 navigates.

The virtual object 1120 is perceived as persisting in the same augmented reality space, relative to visual real-world reference points, as the original placement was intended by the authoring user. The user 1105 is walking around 1115 the object 1120 and regardless of their position, the object 1120 maintains its position and orientation independent of the client device's 1110 position and orientation.

An important aspect is that the object's 1120 position and orientation are solid (i.e. appear to have little or no jitter) when viewed by a user as they move around. This achieved using fine grain motion tracking of the user 1105 over time to determine their location accurately, as well as the fact that the object 1120 is “anchored” to a real world location (i.e. its ENU coordinate space has an origin at a specific GPS location in the real world, and its absolute location is that ENU space is relative to that origin).

Note that whilst a digital media object may appear to be solidly anchored at its origin (i.e. little or no jitter), the digital media object is free to animate and/or move relative to its origin. Such motion and animation may or may not be controlled by a user and this movement operates within its own local coordinate system or relative to another such as the viewer's. If a digital object is capable of moving, a user can still move around it and view it, and do so with the same quality user experience as that with static digital objects which have little or no jitter.

In addition, the ability to reproduce the object's 1120 position and orientation for any user with digital media software, regardless of their device type, is accomplished without the use of computer vision techniques. The various exemplary embodiments herein provide more accuracy and precision than that provided by current computer vision techniques and thus provides a higher quality user experience in terms of faithfully reproducing an object's location and orientation with minimal jitter.

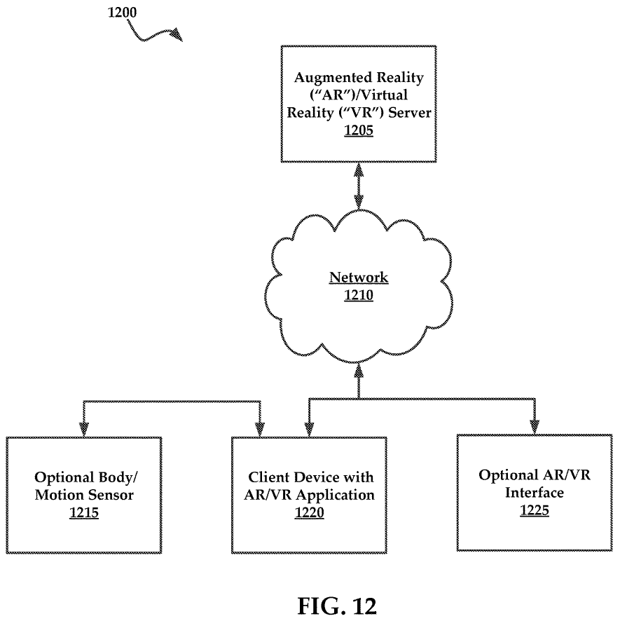

FIG. 12 illustrates an exemplary architecture 1200 depicting the physical system components that could allow for the placement and storage of digital media in an AR or VR environment. This architecture may generally include, but is not limited to, a client device with an AR/VR software application 1220 through which a user interacts with, one or more servers 1205 for storing data from and communicating with client device 1220, and a computer network 1210 over which client device 1220 communicates with the server 1205.

Client device 1220 has software which allows for the creation, placement, and viewing of digital content in an AR/VR world. Client device 1220 may optionally utilize body/motion sensor peripherals 1215 and data to perform client-side tasks, and may optionally provide an AR and/or VR user interface 1225 through which a user may interact with.

Examples of body/motion sensor peripherals 1215 may include, but are not limited to, accelerometers, GPS trackers, and altimeters. Examples of client devices 1220 may include, but are not limited to, cellular phones (aka “smart” phones”), VR headsets/goggles, etc. Examples of optional AR and/or VR user interfaces 1225 may include, but are not limited to: touch screens, handheld controllers (e.g. game pads), AR glasses that display a video stream provided by another client device.

The network 1210 may comprise of a communication path consisting of, but not limited to: the Internet and public and/or private networks. Such communications may take place over wireless and/or wired connections (e.g. Ethernet), using the networking peripherals available on the server 1205 and client device 1220.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the description, for purposes of explanation and not limitation, specific details are set forth, such as particular embodiments, procedures, techniques, etc. in order to provide a thorough understanding of the various exemplary embodiments. However, it will be apparent to one skilled in the art that various exemplary embodiments may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. The description herein is illustrative and not restrictive. Many variations of the technology will become apparent to those of skill in the art upon review of this disclosure.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method comprising:
receiving a reference origin, the reference origin including a first longitude, a first latitude and a first altitude above sea level;
receiving a point of interest, the point of interest including a second longitude, a second latitude and a second altitude above sea level; and
receiving an updated reference origin, the updated reference origin comprising a third longitude, a third latitude and a third altitude above sea level.

2. The method of claim 1, further comprising:
associating digital data with the point of interest.

3. The method of claim 2, further comprising:
adding a 3D offset to the point of interest to determine a location for the point of interest.

4. The method of claim 3, further comprising:
determining a threshold, the threshold representing a predetermined change in distance of the reference origin.

5. The method of claim 4, further comprising:
updating the reference origin when the threshold is met or exceeded.

6. A method comprising:
receiving an initial location, the initial location including GPS coordinates of a client device, an altitude above sea level of the client device and an offset from the altitude above sea level of the client device;
creating by the client device a virtual East North Up coordinate system based on the initial location;
receiving a current course location of the client device, the current course location including new GPS coordinates; and
receiving digital data associated with an offset.

7. The method of claim 6, further comprising:
creating by the client device a virtual East North Up coordinate system based on the initial location.

8. The method of claim 7, further comprising:
the current course location including a new altitude above sea level of the client device.

9. The method of claim 8, further comprising:
recording the current course location and the new altitude above sea level on the client device.

10. The method of claim 9, further comprising:
inputting the current course location and the new altitude above sea level of the client device into a filter.

11. The method of claim 10, further comprising:
fusing the filtered information with data from sensors to estimate a position in East North Up coordinates.

12. A method comprising:
receiving an initial location;
receiving a current course location;
determining a difference between the initial location and the current course location;
receiving acceleration data and GPS speed;
filtering the acceleration data, the GPS speed and the difference with a filter; and
outputting improved location coordinates.

13. The method of claim 12, further comprising:
filtering latitude, longitude, and altitude data with the filter.

14. A method comprising:
receiving location data, the location data including GPS coordinates;
formatting the location data for a filter;
inputting the location data into the filter; and
filtering by the filter the location data and altitude data.

15. The method of claim 14, further comprising:
obtaining from a sensor on a client device additional data for filtering by the filter.

16. A system comprising:
a computing device, the computing device further comprising:
a GPS receiver;
a sensor;
a network communication means communicatively coupled to the GPS receiver, the sensor and a network; and
a filter communicatively coupled to the computing device.

17. The system of claim 16, further comprising:
the filter including a data converter, and a filter.

18. A method comprising:
viewing through a viewport on a client device a first 3D digital media object placed in an augmented reality space, the first 3D digital media object remaining in a fixed position within the augmented reality space while moving the client device in a real world setting.

19. The method of claim 18, the moving further comprising:
receiving an initial location, the initial location including GPS coordinates of the client device, an altitude above sea level of the client device and an offset from the altitude above sea level of the client device;
creating by the client device a virtual linear coordinate reference system based on the initial location;
receiving a current course location of the client device, the current course location including new GPS coordinates; and
receiving digital data associated with an offset.

20. The method of claim 18, further comprising the moving of the client device in the real world setting including moving around the first 3D digital media object that remains in the fixed position.

21. The method of claim 18, wherein the first 3D digital media object was placed in the augmented reality space by a third party.

22. The method of claim 18, wherein the first 3D digital media object was placed in the augmented reality space by a user of the client device.

23. The method of claim 21, further comprising a user of the client device placing a second 3D digital media object relative to the first 3D digital media object.

24. The method of claim 22, further comprising a third party placing a second 3D digital media object relative to the first 3D digital media object.
